(19) United States
(12) Patent Application Publication
(10) Pub. No.: US 2026/0349789 A1
(43) Pub. Date: Nov. 5, 2026

(54) PREEMPTING PIPELINE NODES IN HETEROGENEOUS COMPUTING CLUSTERS

(71) Applicants: Rajendrakumar Chinnaiyan, Portland, OR (US); Amruta Misra, Bangalore (IN)

(72) Inventors: Rajendrakumar Chinnaiyan, Portland, OR (US); Amruta Misra, Bangalore (IN)

(21) Appl. No.: 19/720,769

(22) Filed: Jun. 25, 2026

(51) Int. Cl. G06F 9/48

(52) U.S. Cl. CPC G06F 9/4881

(57) ABSTRACT

Various aspects of preempting and configuring pipeline computing operations are described. In an example, an orchestrator is able to tune the performance of various computing nodes and accompanying system, SoC, core, or IO peripheral-level performance settings, based on a processing pipeline for a workload. An example method includes: analyzing characteristics of a workload to be performed in a processing pipeline; identifying at least one subsequent node projected to perform at least one subsequent stage in the processing pipeline, based on the characteristics of the workload; and providing a command to the at least one subsequent node to preemptively change the at least one subsequent node into a ready state to perform the workload. This changes the at least one subsequent node into a ready state, before the operations of the workload are transferred to the at least one subsequent node via the processing pipeline.

### BACKGROUND

Data centers and cloud computing system implementations include many variations of compute, memory, input/output (IO), and storage resources to support distributed software services, such as for executing artificial intelligence (AI) workloads and applications organized as collections of microservices. A microservice-based application generally includes a software application that partitions functionality into separate services that communicate with one another. As a result, a microservice-based application may perform a defined portion of a larger workload or task across processing hardware, including among different central processing unit (CPU), graphics processing unit (GPU), and tensor processing unit (TPU) hardware.

To support different processing types, cloud service providers (CSPs) and other data center operators often configure and operate clusters of heterogeneous nodes of different capabilities. In these clusters of heterogeneous nodes, individual nodes are often configured to specialize in particular categories of work, such as compute nodes, storage nodes, and IO nodes. Other types of nodes may incorporate dedicated hardware components, including AI accelerators and cryptographic accelerators.

The arrangement and configuration of such clusters may lead to complex scenarios. From the point of view of workloads, depending on the nature of the workload, different services may be deployed at different times, in different nodes, for different purposes (e.g., a database service running on a storage node at a later time, an inferencing service running on a node that has AI acceleration built-in throughout the entire workload process, or an encryption service running on a node with built-in cryptography acceleration that only runs in response to a particular condition). The many occurrences of handoffs and the variations among different nodes, especially in a microservices setting, may also result in inefficiencies or processing delays.

### BRIEF DESCRIPTION OF THE DRAWINGS

In the drawings, which are not necessarily drawn to scale, like numerals may describe similar components in different views. Like numerals having different letter suffixes May represent different instances of similar components. The drawings illustrate, generally, by way of example, but not by way of limitation, various embodiments discussed in the present document.

FIG. 1A depicts a system architecture of an example microservices deployment across a heterogeneous cluster of nodes.

FIG. 1B depicts the system architecture of FIG. 1A in a reduced power state.

FIG. 2 depicts a flowchart of an example method for preempting and tuning pipeline nodes.

FIG. 3 depicts the system architecture of FIG. 1A with an orchestrator that preempts and tunes pipeline nodes.

FIG. 4 depicts a flowchart of a method of servicing an end-to-end microservices request.

FIG. 5 depicts a flowchart of a method of servicing an end-to-end microservices request using modified performance modes.

FIG. 6 depicts a flowchart of a method for preemptively changing one or more subsequent nodes of a processing pipeline into a ready state.

FIG. 7A provides an overview of example components deployed at a computing device.

FIG. 7B provides a further overview of example components within a computing device.

### DETAILED DESCRIPTION

The following discusses improvements to data pipeline processing and related workload executions in computer systems. Various methods, devices, systems, and computer-readable instructions are described to reduce the time and power needed to service a workload request, including for workload requests that traverse a sequence of microservices hosted by different nodes of a heterogeneous computing cluster. In one of many examples, the reduction or optimization of processing time and resources can be achieved by pre-emptively preparing the subsequent nodes to be used in a ready state to perform the specific role or task of the workload. This can include pre-emptively transitioning a node that hosts a later-used microservice (e.g., a microservice to be executed later in an ongoing sequence of workload execution) into a high-performance or powered-up state before the request reaches that node.

In some examples, an orchestrator that manages the workload sequence receives, while a request is being processed at a current node, information that identifies a later microservice (“subsequent microservice”) in the sequence and the node that hosts the later microservice. The orchestrator determines an operational stage (such as a power state) of the identified node. For instance, when the identified node is in a low-power state, the orchestrator transitions the identified node to a full-power or another high-performance state. The transition may include adjusting one or more of a system-on-chip performance mode, a processor core performance state, an input/output peripheral power state, or a performance state of a specialized processing device (e.g., a cryptographic accelerator, an artificial intelligence accelerator, or another accelerator located at the node or accessible through an add-in card).

In some examples, the workload information is generated by the current microservice based on information made available to it during data processing. As a result, the subsequent microservice can be identified even while data processing at the current node is still in progress. In some examples, the orchestrator keeps a data record or data mapping that associates a microservice with the node that hosts it. This data record or mapping may be populated in a microservices register maintained with the orchestrator.

In some examples, the orchestrator manages operational stages of respective nodes to improve the performance of more than one subsequently executed microservice. The heterogeneous cluster nodes are then transitioned to performance states selectively, in correspondence with the path the request is expected to take through the workflow sequence. For example, a node hosting a microservice two or more positions ahead in the workflow sequence can be transitioned to a performance state while the current node is still processing. Also, for example, a node that is not identified as hosting a later microservice can be maintained in a lower-power state. Or, for example, if the identified node is already in a performance state and is processing other workload requests, the orchestrator sends a notification of the incoming request to the identified node (instead of transitioning the node to a high-performance mode).

Some approaches attempt limited changes for workflow processing activities. These approaches have included:

(i) Keeping all servers in a high-performance/high-power mode. While this helps achieve the desired SLA (Service Level Agreement) or SLO (Service Level Objective), this approach eventually results in higher power consumption when there are no requests posted to the server or the particular node.

(ii) Increasing the SLA for microservice processing, such as by idling a large number of nodes in power save mode. This approach eventually compromises the end customer experience and provides a poor implementation of the microservices framework.

(iii) Hosting all of the microservices within a same node. This approach results in sub-optimal performance of individual microservices and an overall higher execution time (which may not meet an SLA). This also compromises distributed or redundant aspects of the microservices framework and impacts end-user experiences.

Some of the technical problems addressed by the present disclosure arise in a heterogeneous cluster in which a workload request traverses a sequence of microservices hosted on different nodes, where the nodes are idle or are lightly loaded (and held in lower-power states). Under existing power management scenarios, a node hosting a downstream microservice transitions from a lower-power state to a performance state only after the request reaches that node and a load condition at that node is satisfied. The duration of this transition is added to the processing time of the request at a downstream node in the sequence, increasing the cumulative time and processor cycles expended to service the request across the cluster.

Some of the technical solutions discussed herein include orchestration or management operations, including specific adjustment of on-chip performance modes, processor core performance states, input/output peripheral power states, or accelerator device performance states, before a request reaches the implementing node. The resulting effect is that the transition time of a downstream node to a performance state can be reduced or removed from the total processing time of the request at that node. This reduces the cumulative processing time and the number of processing cycles expended to service the request across the sequence of nodes, and increases processing speed. This can enable nodes that are not identified as subsequent nodes (e.g., nodes that will not be used with the workload) to be transitioned into idle or low-power states or remain in idle or low-power states. Such granular control can help reduce the overall power and resource consumption for the individual nodes and the overall cluster.

Thus, the following introduces improved techniques to increase the performance of time-sensitive workloads. Many of the examples below involve techniques to address the delays caused by a late ramp of subsequent microservices (e.g., n+1, n+2 microservices), by pre-empting and ramping-up the next N+1th (or N+2, N+3, etc.) microservice expected to be used during the Nth process. This can be accomplished using a variety of software techniques that help a branch predict the next operation used in the pipeline. Other optimization techniques may also be used to help transition subsequent nodes into the ready state.

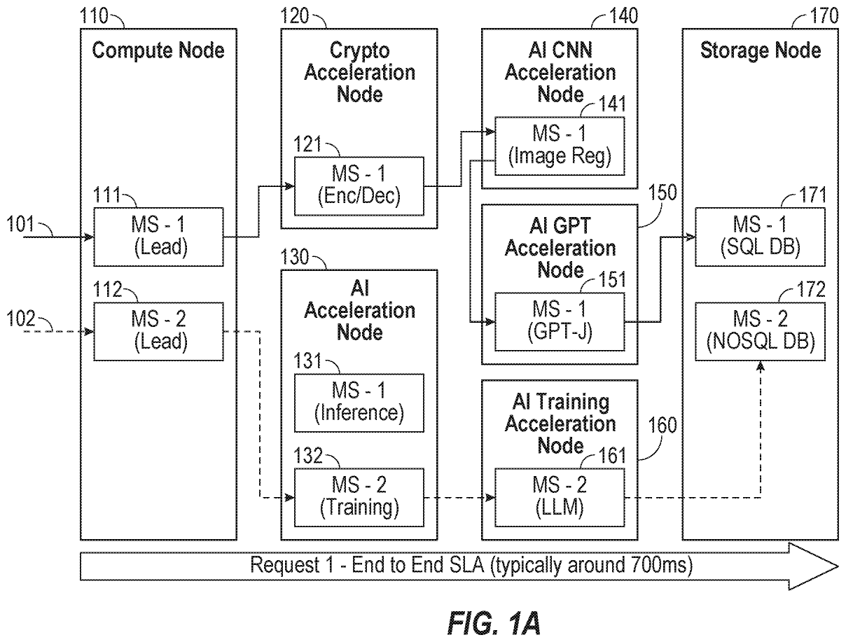

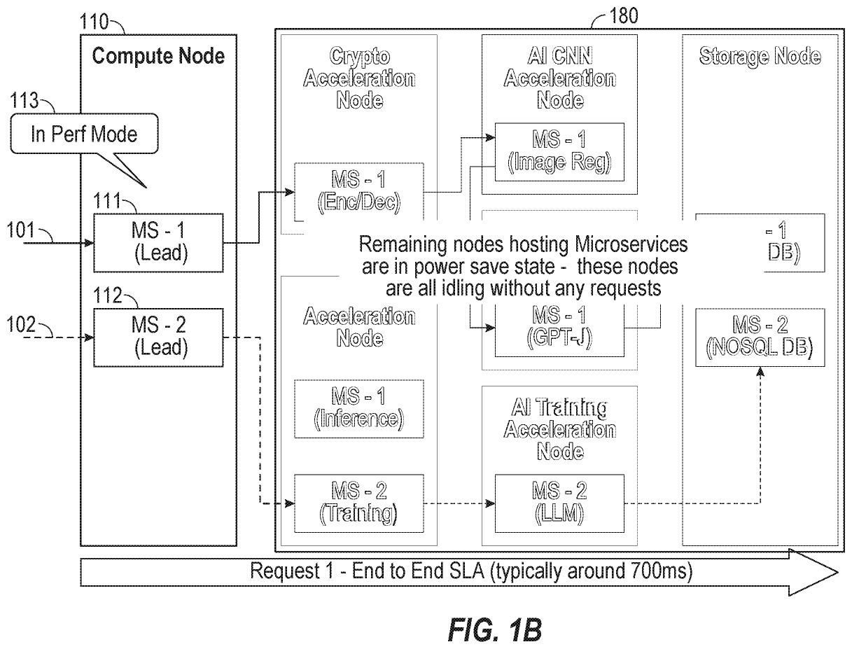

FIG. 1A illustrates a system architecture of an example microservices deployment across a heterogeneous cluster of nodes. The deployment includes a compute node 110, a cryptographic acceleration node 120, an artificial intelligence (AI) acceleration node 130, an AI convolutional neural network (CNN) acceleration node 140, an AI generative pre-trained transformer (GPT) acceleration node 150, an AI training acceleration node 160, and a storage node 170. A node hosts one or more microservices (MS) that perform a function corresponding to the configuration of the node, and the nodes are arranged to process a request as it passes from one node to a subsequent node along a processing pipeline.

In many scenarios, nodes in a microservice deployment will receive a single request and expect the overall request to be serviced within the SLA (Service Level Agreement) of some defined measure of milliseconds or microseconds (e.g., 700 ms). However, in a distributed service hosting setup, one major challenge is that some of the nodes that are expected to be used during later states of an active request may not be ready to service requests. For instance, a database node will stay in a power-saving (low-power) or low-performance mode when there is no active database request to process, and an AI node will likewise stay in a power-saving (low-power) or low-performance mode when there is no active inferencing request to process.

Consider the following sequence shown in FIG. 1A. The compute node 110 hosts a first lead microservice 111 MS-1 and a second lead microservice 112 MS-2. An input request for a first workload (a first workload request 101) is received at the first lead microservice 111, and a second input request for a second workload (a second workload request 102), shown by a dashed line to indicate an alternative path, is received at the second lead microservice 112. The first lead microservice 111 and the second lead microservice 112 manage the overall requests and direct portions of the requests to select downstream nodes.

The cryptographic acceleration node 120 hosts an encryption/decryption microservice 121 MS-1 (Enc/Dec). The first lead microservice 111 passes the request to the encryption/decryption microservice 121, which performs encryption or decryption on data associated with the first workload request 101, for example, decompressing or decrypting incoming data before further processing. The AI CNN acceleration node 140 hosts an image recognition microservice MS-1 (Image Reg) 141. The encryption/decryption microservice 121 passes the first workload request 101 to the image recognition microservice 141, which performs image recognition (e.g., with textual output) using a convolutional neural network. The AI GPT acceleration node 150 hosts a GPT-J microservice MS-1 (GPT-J) 151, which performs language model processing using a GPT model (e.g., a large language model). The image recognition microservice 141 passes the request to the GPT-J microservice 151 for generative or language-model processing.

Separately, the second workload request 102 is processed. The second lead microservice 112 directs the second workload request along the dashed path to the training microservice 132. The AI acceleration node 130 hosts an inference microservice MS-1 (Inference) 131 and a training microservice MS-2 (Training) 132. The inference microservice 131 performs AI inferencing tasks, whereas the training microservice 132 performs AI training tasks. The AI training acceleration node 160 hosts a large language model microservice MS-2 (LLM) 161. The training microservice 132 passes the second workload request 102 along the dashed path to the LLM microservice 161, to perform large language model training tasks.

The storage node 170 hosts a SQL database microservice MS-1 (SQL DB) 171 and a NoSQL database microservice MS-2 (NOSQL DB) 172. The image recognition microservice 141 and the GPT-J microservice 151 pass the first workload request 101 to the storage node 170, where results are written to the SQL database microservice 171. The LLM microservice 161 passes the second workload request 102 to the NoSQL database microservice 172. Other data operations may also occur in connection with these microservices and nodes.

A request flow at the lower portion of FIG. 1A labeled “Request 1-End to End SLA” represents the service level agreement applied to the request as it traverses the pipeline from the compute node 110 through the acceleration nodes 120, 130, 140, 150, 160 to the storage node 170. The solid-line path (originating from the first workload request 101) and the dashed-line path (originating from the second workload request 102) represent separate routes that a request may take through different subsets of the nodes, depending on the services the request requires.

FIG. 1B illustrates a system architecture of an example microservices deployment, showing the power states of the nodes depicted in FIG. 1A. FIG. 1B shares the node arrangement and reference numerals introduced in FIG. 1A, discussed above. In this arrangement, the nodes within boundary 180 are in a power save state (e.g., low-power state). In other words, these nodes (and the microservices on these nodes) are idling and are held in a power save state.

In FIGS. 1A and 1B, the various workload requests are processed in a serial manner, passing from one node to a subsequent node. In conventional approaches, this means that a node used at a later stage of the request may remain in a lower-power state until the request reaches that node, and only at that point will the node transition to a performance mode to begin processing. Only when the actual requests reach the desired node, does the node transition into a performance mode and only then does the node start the processing of the request (and in some cases, the performance mode is used only if the request load is significant). This means that much of the time, there are ramp time delays for the processing of the requests. In this context, a ramp time delay is the delay from preparing the platform for actually executing the microservice and may include actions such as increasing power to one or more cores of the node, provisioning virtual machines, initializing operating systems, performing authentication or attestation, enabling logging, or the like.

A performance-mode indicator 113, labeled “In Perf Mode,” denotes that the compute node 110 (which is currently receiving and processing the first workload request 101 and the second workload request 102 at the first lead microservice 111 and the second lead microservice 112) is operating in a performance mode. The remaining nodes hosting microservices within the system boundary 180 are in a power save state and these nodes are idling without any requests.

The present approaches provide improved techniques to evaluate workload and microservices inputs at runtime, to adjust the system hardware and resource performance settings (e.g., system/SoC/core/IO peripheral level performance settings) on-demand in a pre-emptive manner before the next required microservice is executed. These techniques can also coordinate execution and resource optimization operations to ensure the best performance of the respective microservices. This performance adjustment and optimization can lead to a 20-30% performance-per-watt improvement in some settings.

In an example, node management functionality is added or modified in a cloud service orchestrator, controller, or similar workload manager. The orchestrator, controller, or workload manager receives runtime inputs from microservices and pre-emptively adjusts relevant system/SoC/core/IO peripheral level performance settings and power modes at multiple subsequent nodes to ensure the best performance of the respective microservice at future times in connection with workload handoffs. This helps avoid the ramp-up time to ensure the subsequent (N+1) node that is supposed to service the workload is in a ready state. For example, in the case of generative AI workloads, the first container running on “node 1” after a certain time knows (or can predict) what expected resources are needed for the next operation, which can be used as a signal to the next (subsequent) node. This information can be used to change performance operations and help improve the performance relative to the SLA, while also improving performance-per-watt, and related metrics such as total cost of ownership.

When deploying microservices, the node management functionality is registered with the orchestrator, controller, or workload manager. The node management functionality may use a mapping (e.g., as shown in Table 1-Database of Microservices, below) of which microservice runs on which node and the primary purpose of the microservice. By knowing the respective node and the purpose of the microservice, the management functionality can easily tune or tweak the system/SoC/core/IO peripheral level performance settings at the respective node(s), to yield the best available performance for the expected type of microservice execution.

TABLE 1
DATABASE OF MICROSERVICES

| Solution | Service | Node |
|---|---|---|
| MS-1 (Search Engine) | Lead | Node2 |
| MS-1 (Search Engine) | Cryptographic | Node10 |
| MS-1 (Search Engine) | Image Recognition (AI CNN) | Node88 |
| MS-1 (Search Engine) | GPT-J (LLM) | Node14 |
| MS-1 (Search Engine) | Database (SQL DB) | Node134 |
| MS-2 (Translator) | Lead | Node2 |
| MS-2 (Translator) | AI Inference (LLM) | Node32 |
| MS-2 (Translator) | AI Training (LLM) | Node33 |
| MS-2 (Translator) | Database (NOSQL) | Node144 |

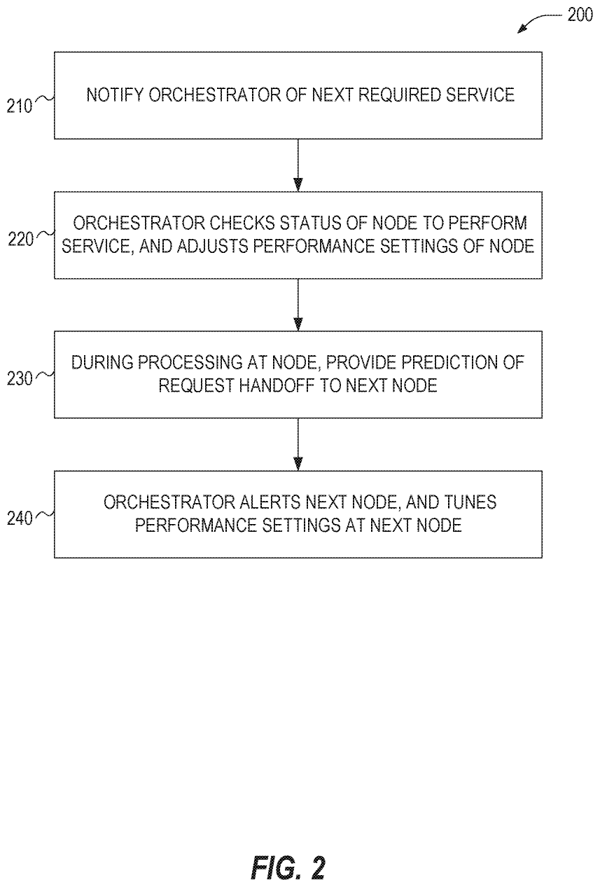

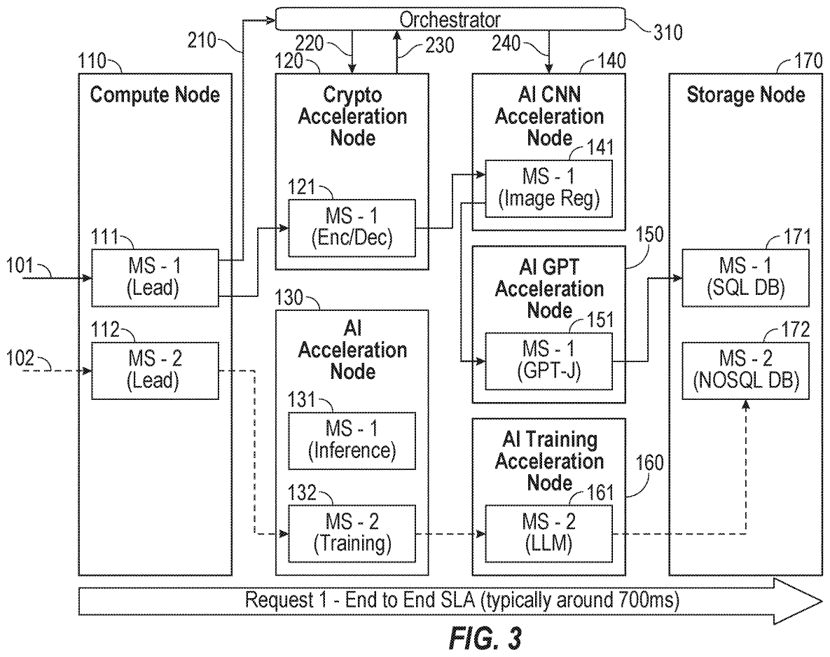

FIG. 2 illustrates a flowchart 200 of an example method for preempting and tuning pipeline nodes by an orchestrator or similar component. FIG. 3 illustrates a system architecture of an example microservices deployment including an orchestrator that preempts and tunes pipeline nodes in a heterogeneous computing cluster, based on the method of flowchart 200. The system architecture in FIG. 3 depicts a scenario based on the architecture in FIG. 1A and FIG. 1B in which a request passes serially from node to node, using an orchestrator 310 to perform the method of flowchart 200 with operations 210, 220, 230, and 240 as follows.

At operation 210, the orchestrator is notified of the next required microservice. In the middle of a processing request, the lead (or “master”) service notifies the orchestrator 310 of the next required service (e.g., as shown in FIG. 3, the next service is a cryptographic service in a scenario where cryptographic processing is needed for decompressing the incoming data).

At operation 220, the orchestrator 310 checks the status of the node to perform the service and adjusts the performance settings of the node. For instance, as soon as the orchestrator 310 receives the input, it then checks the status of the node that hosts the cryptographic service. If the node is idling and there is no request being processed, then the orchestrator 310 will adjust the performance settings of the node (e.g., enable SoC performance mode, wake IO devices from sleep, or if the node uses an add-in card-based cryptographic accelerator, then enable performance mode on it, etc.). If the node (e.g., cryptographic acceleration node 120) is currently handling other cryptography requests, it notifies the node that there is another request incoming and requests the node to be ready in a performance state.

At operation 230, a prediction of a request handoff to a next node is provided, during processing at a node. For example, once the request reaches the cryptographic service of FIG. 3 and while it is processing the data, the cryptographic service predicts that for the next stage the request is to be passed down to an AI Acceleration node for image recognition. Immediately, this service notifies the orchestrator 310 that the subsequent node (e.g., AI CNN acceleration node 140) must be ready to service this request.

At operation 240, the orchestrator 310 alerts the next node (AI CNN acceleration node 140) and tunes the performance settings at this next node. At this point, the orchestrator 310 has the next required service details and the node information. The orchestrator 310 then alerts the node (the AI CNN acceleration node 140) to be ready to service an image recognition task. The specific task may be performed by a CPU/GPU/TPU, with the specific hardware used entirely depending on the nature of the service configured, or how the microservice has tuned the performance settings.

The sequence of operation 210 through operation 240 represents one iteration of the preemption process, and the method of flowchart 200 may repeat across successive node transitions along the pipeline. For instance, a node may predict the handoff to its respective next (subsequent) node as the orchestrator preemptively tunes the performance settings of that next (subsequent) node before the request arrives. Other variations of this operation sequence may be provided.

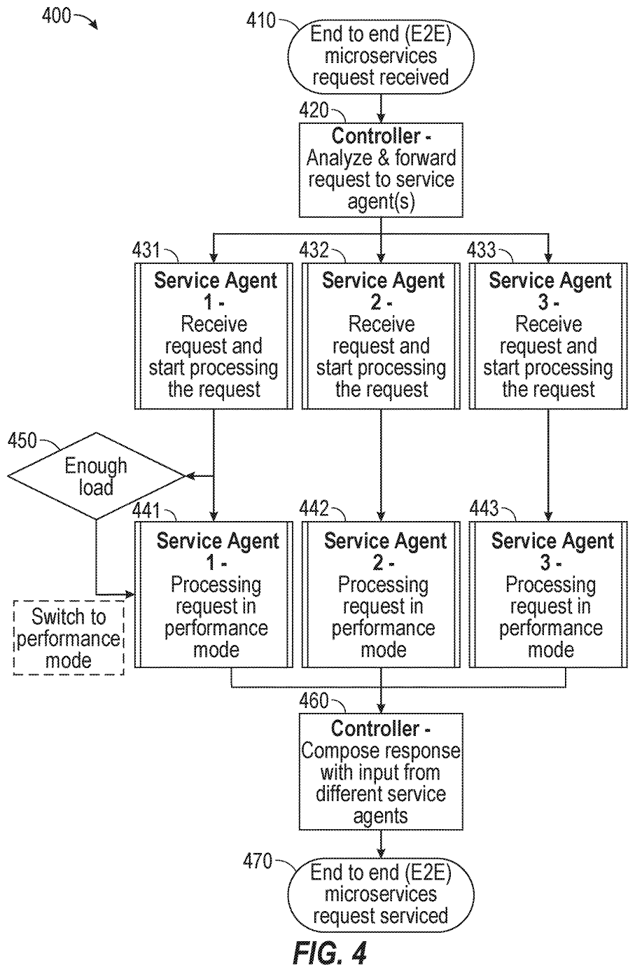

FIG. 4 provides a flowchart 400 of additional technical details in connection with a method of servicing an end-to-end microservices request using a controller and a plurality of service agents. The method processes an end-to-end microservices request through a controller and a set of service agents, and includes a load-based determination of whether to switch a service agent to a performance mode. It will be understood that this servicing approach may be used in combination with the preemptive scheduling approach in many scenarios.

At operation 410, an end-to-end (E2E) microservices request is received. Operation 410 corresponds to the arrival of a request, such as the first workload request 101 received at the compute node 110 discussed above. At operation 420, the controller analyzes the request and forwards the request to one or more service agents. The controller distributes the request to a first service agent, a second service agent, and a third service agent, such as with separate agents provided by the use of respective containers, engines, services, or hardware nodes. In some examples, the controller of operation 420 corresponds to the function performed by a lead microservice, such as the first lead microservice 111 or the second lead microservice 112, and a respective service agent corresponds to a microservice hosted on a respective node, such as the encryption/decryption microservice 121, the inference microservice 131, or the image recognition microservice 141 discussed above.

At operation 431, the first service agent receives the request and starts processing the request. At operation 432, the second service agent receives the request and starts processing the request. At operation 433, the third service agent receives the request and starts processing the request. Operations 431, 432, and 433 represent the initial receipt and start of processing at the three service agents in parallel (or in a staggered fashion, asynchronously, etc.).

At operation 441, the first service agent processes the request in a performance mode. At operation 442, the second service agent processes the request in the performance mode. At operation 443, the third service agent processes the request in the performance mode. Operations 441, 442, and 443 follow operations 431, 432, and 433, respectively, and represent a service agent continuing to process the request after a transition to the performance mode.

At evaluation operation 450, a determination is made (e.g., based on percentage utilization, queue size, etc.) whether the request load at a service agent is sufficient to warrant operation of the node in the performance mode. If the determination at evaluation operation 450 is negative (No), the processing continues without a further mode transition. If the determination at evaluation operation 450 is affirmative (Yes), a switch-to-performance-mode operation is performed. This load-based gating at evaluation operation 450 corresponds to the condition described in connection with FIG. 1B, in which a node transitions into the performance mode when the request load is significant.

At operation 460, the controller composes a response with input from the different service agents, such as by aggregating the outputs of the operations 441, 442, and 443 into a single response. At operation 470, the end-to-end (E2E) microservices request is completed.

With conventional implementations of the workflow of FIG. 4, a respective service agent receives the request and starts processing at operations 431, 432, and 433 before transitioning to the performance mode at operations 441, 442, and 443, with the transition gated by the load determination at evaluation operation 450. This arrangement incurs a ramp time, because in many scenarios a service agent begins processing before reaching the performance mode, or transitions to the performance mode only after the load determination.

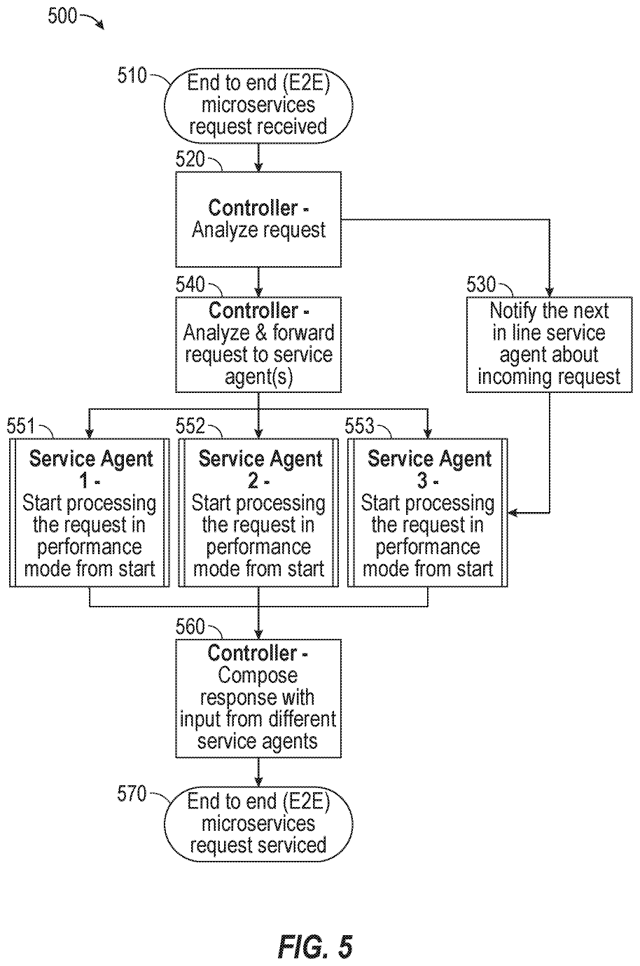

FIG. 5 illustrates a flowchart 500 of an example method for servicing an end-to-end microservices request, in which service agents are notified in advance and process the request in a performance mode from the start, based on the presently disclosed techniques. Similar to FIG. 4, the method processes an end-to-end microservices request through a controller and a set of service agents. However, this method contrasts with FIG. 4 by providing a notification of an incoming request.

At operation 510, an end-to-end (E2E) microservices request is received. Operation 510 is the entry point of the method and corresponds to the arrival of a request, such as the first workload request 101 received at the compute node 110. At operation 520, the controller analyzes the request. This examines the received request to determine the services that the request requires and the nodes that are projected to perform those services. Again, the controller of operation 520 corresponds to the function performed by a lead microservice, such as the first lead microservice 111.

At operation 530, the next-in-line service agent is notified about the incoming request. Operation 530 provides advance notification to a service agent projected to service a subsequent stage of the request, so that the notified service agent is prepared to process the request in the performance mode before the request reaches that service agent.

At operation 540, the controller analyzes and forwards the request to one or more service agents. Operation 540 distributes the request from the controller to a first service agent, a second service agent, and a third service agent, corresponding to the distribution function of operation 420 of FIG. 4.

At operation 551, the first service agent starts processing the request in the performance mode from the start (as the first service agent is already in the performance mode when receiving the request). At operation 552, the second service agent also starts processing the request in the performance mode from the start (as the second service agent is already in the performance mode when receiving the request). At operation 553, the third service agent starts processing the request in the performance mode from the start (as the third service agent is already in the performance mode when receiving the request). Because the next-in-line service agent is notified in advance at operation 530, the third service agent at operation 553 is already in the performance mode when the request arrives at a later time.

At operation 560, the controller composes a response with input from the different service agents. This operation can include aggregating the outputs of the performance-mode operations 551, 552, and 553 into a single response. At operation 570, the end-to-end (E2E) microservices request is completed.

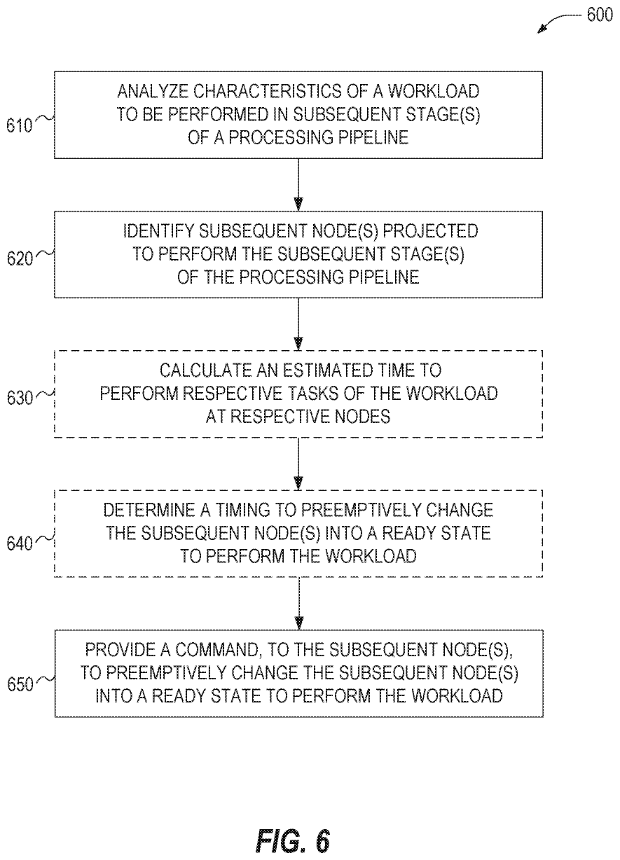

FIG. 6 illustrates a flowchart 600 of an example method for preemptively changing one or more subsequent nodes of a processing pipeline into a ready state. Consistent with the examples above, the method prepares one or more nodes of a compute cluster that are projected (e.g., scheduled, forecasted, or probabilistically likely) to perform later stages of a processing pipeline so that those nodes are ready before the workload reaches them. The method may be performed by a device or system, such as by a computing system that includes processing circuitry and a memory device storing instructions that, when executed by the processing circuitry, carry out the operations of the method. The device or system may operate as an orchestrator or controller that is connected to the compute cluster, such as the orchestrator 310 as discussed above.

At operation 610, the device or system analyzes characteristics of a workload to be performed in one or more subsequent stages of a processing pipeline. Operation 610 examines the workload, including future operations that are to be performed in at least one subsequent stage of the pipeline. The workload examined at operation 610 includes various tasks or processes spun up by the microservices as the processing pipeline moves the workload from one node to a subsequent node.

At operation 620, the device or system identifies one or more subsequent nodes projected to perform the subsequent stages of the processing pipeline. Operation 620 selects, based on the characteristics analyzed at operation 610, at least one subsequent node projected to perform the subsequent stage, with a selection made from among the different node locations of a set of heterogeneous nodes. In some examples, the set of heterogeneous nodes is drawn from a combination of at least two of: compute nodes, storage nodes, cryptographic acceleration nodes, and AI acceleration nodes.

At operation 630, the device or system optionally calculates an estimated time to perform the respective tasks of the workload at the individual (respective) nodes. This operation produces, for each identified node, an estimate of how long the tasks of the workload will take at that node. The respective tasks performed at the individual nodes use at least one microservice at each node, and the processing pipeline communicates results from an earlier node to a later node used in a sequence of the processing pipeline, such as provided by the microservices and the inter-node data paths discussed above.

At operation 640, the device or system optionally determines a specific time (e.g., a “ready time”) to preemptively change the one or more subsequent nodes into a ready state to perform the workload. This operation identifies, based on the estimated times calculated at operation 630, when to issue the change for an individual node, taking into account the estimated task times relative to the time requirements of a service-level agreement.

At operation 650, the device or system provides a command to the one or more subsequent nodes to preemptively change the subsequent nodes into a ready state to perform the workload. This operation sends the command so that a subsequent node enters the ready state before the operations of the workload are transferred to that node along the pipeline. The ready state may take one of several forms. In one example, the ready state uses a high-performance setting at the subsequent node, and the high-performance setting is applied by changing at least one of a circuitry performance mode, a processor core performance state, an input/output peripheral power state, or an accelerator device performance state. These changes correspond to the performance-setting adjustments described for operation 220 (e.g., enabling an SoC performance mode, waking I/O devices from sleep, and enabling a performance mode on an add-in-card cryptographic accelerator).

In a further example, the command of operation 650 causes the subsequent node to change from a low-power state to a high-performance state before the workload is transferred to that node, such as from the transition of a node out of a power-save state. In a further example, the command of operation 650 causes the subsequent node to stay in a high-performance state and to avoid transitioning to a low-power state before the workload is transferred. This can keep a node that is already active in a performance mode rather than allowing it to return to a power-save state.

The method may also manage nodes that are not directly invoked by the workload. The device may identify at least one unused node of the compute cluster that is not scheduled to perform the workload, and the orchestrator or controller provides a command to keep or transition that unused node into a reduced performance state. The method may also add capacity when an identified node lacks sufficient resources. The device or system may instantiate an additional node within the processing pipeline when it determines that a subsequent node associated with a microservice has surpassed, or is projected to surpass, a resource utilization limit. This corresponds to bringing up and provisioning a further node when a node already operating near its utilization limit cannot absorb the incoming request.

In further examples, the command of operation 650 may also modify an active process being executed at the subsequent node. The command to preemptively change the subsequent node into the ready state may include preempting or reducing the priority of an active process at that node, so as to reserve resources for the workload. For instance, this may be implemented by interrupting an in-progress task at a node, such as stopping a video generation operation when a changed request arrives, so that resources are made available for the incoming workload.

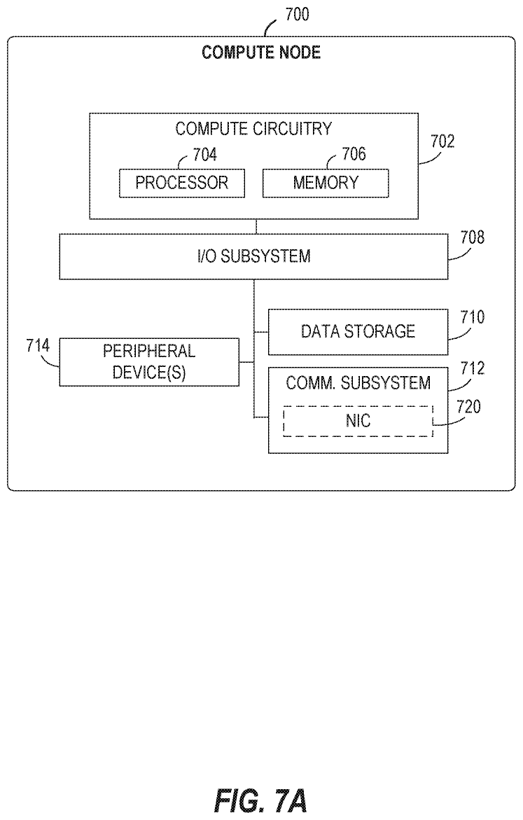

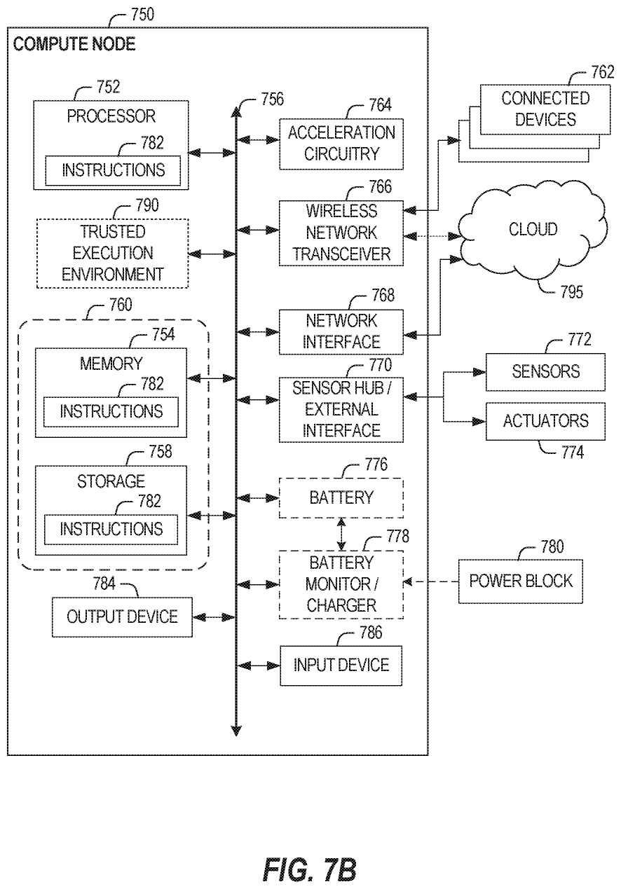

Any of the computing nodes or devices used to implement the aforementioned techniques may be implemented based on the components of a compute node as depicted in FIGS. 7A and 7B. Respective compute nodes may be embodied as a type of device, appliance, computer, or other “thing” capable of communicating with other edge, networking, or endpoint components. For example, a compute device may be embodied as a robot, a robot control system, a personal computer, a server, a mobile computing device, a smart appliance, an in-vehicle compute system (e.g., a navigation system), a self-contained device having an outer case, shell, etc., or other device or system capable of performing the described functions.

In the simplified example depicted in FIG. 7A, a compute node 700 includes a compute engine (also referred to herein as “compute circuitry”) 702, an input/output (I/O) subsystem 708, a data storage device 710, a communication circuitry 712 subsystem, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special-purpose processing unit, or other processor or processing/controlling circuit.

In some examples, the processor 704 may be embodied as, include, or be coupled to an FPGA, an application-specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general-purpose processing hardware. However, it will be understood that an xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross-point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation, such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data, such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems, depending on, for example, the type of compute node 700.

The communication circuitry 712 may be embodied as any communication circuit, device, or collection thereof, capable of enabling communications over a network between the compute circuitry 702 and another compute device (e.g., a gateway of an implementing computing system). The communication circuitry 712 may be configured to use one or more communication technologies (e.g., wired or wireless communications) and associated protocols (e.g., a cellular networking protocol such as a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., a gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, or other levels.

Additionally, in some examples, a respective compute node 700 may include one or more peripheral devices 714. Such peripheral devices 714 may include any type of peripheral device found in a compute device or server, such as audio input devices, a display, other input/output devices, interface devices, and/or other peripheral devices, depending on the particular type of the compute node 700. In further examples, the compute node 700 may be embodied by a respective compute node (whether a client, gateway, or aggregation node) in a computing system or like forms of appliances, computers, subsystems, circuitry, or other components.

In a more detailed example, FIG. 7B illustrates a block diagram of an example of components that may be present in a computing node 750 for implementing the techniques (e.g., operations, processes, methods, and methodologies) described herein. This computing node 750 provides a closer view of the respective components of node 700 when implemented as or as part of a computing device (e.g., as a mobile device, a base station, server, gateway, etc.). The computing node 750 may include any combinations of the hardware or logical components referenced herein, and it may include or couple with any device usable with a communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the computing node 750, or as components otherwise incorporated within a chassis of a larger system.

The computing node 750 may include processing circuitry in the form of a processor 752, which may be a microprocessor, a multi-core processor, a multithreaded processor, an ultra-low voltage processor, an embedded processor, an xPU/DPU/IPU/NPU, special-purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, California. As an example, the processor 752 may include an Intel® Architecture Core™ based CPU processor, such as a Quark™, an Atom™, an i3, an i5, an i7, an i9, or an MCU-class processor, or another such processor available from Intel®. However, any number of other processors may be used, such as those available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd., or a customer thereof, or their licensees or adopters. The processors may include units such as an A5-A19 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types, such as single die package (SDP), dual die package (DDP), or quad die package (QDP). These devices, in some examples, may be directly soldered onto a motherboard to provide a lower profile solution, while in other examples, the devices are configured as one or more memory modules that in turn couple to the motherboard by a given connector. Any number of other memory implementations may be used, such as other types of memory modules, e.g., dual inline memory modules (DIMMs) of different varieties, including but not limited to microDIMMs or MiniDIMMs.

To provide for persistent storage of information, such as data, applications, operating systems, and so forth, a storage 758 may also be coupled to the processor 752 via the interconnect 756. In an example, the storage 758 may be implemented via a solid-state disk drive (SSD). Other devices that may be used for the storage 758 include flash memory cards, such as Secure Digital (SD) cards, microSD cards, extreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low-power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such as resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI Express (PCIe), or any number of other technologies. The interconnect 756 may be a proprietary bus, for example, used in an SoC-based system. Other bus systems may be included, such as an Inter-Integrated Circuit (I2C) interface, a Serial Peripheral Interface (SPI) interface, point-to-point interfaces, and a power bus, among others.

The interconnect 756 may couple the processor 752 to a transceiver 766, for communications with the connected devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at different ranges. For example, the computing node 750 may communicate with close devices, e.g., within about 7 meters, using a local transceiver based on Bluetooth Low Energy (BLE), or another low-power radio, to save power. More distant connected devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in the cloud 795 via local or wide area network protocols. The wireless network transceiver 766 may be a low-power wide-area (LPWA) transceiver that follows the IEEE 802.15.4, or IEEE 802.15.4g standards, among others. The computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low-bandwidth communications, such as Sigfox, and other technologies. Further, other communications techniques, such as time-slotted channel hopping, described in the IEEE 802.15.4e specification, may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium-speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the cloud 795 or to other devices, such as the connected devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components (circuitry 764, transceiver 766, NIC 768, or interface 770). Accordingly, in various examples, applicable means for communicating (e.g., receiving, transmitting, etc.) may be embodied by such communications circuitry.

The computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the computing node 750 to actuators 774, such as power switches, valve actuators, an audible sound generator, a visual warning device, and the like.

In some optional examples, various input/output (I/O) devices may be present within or connected to the computing node 750. For example, a display or other output device 784 may be included to show information, such as sensor readings or actuator position. An input device 786, such as a touch screen or keypad, may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the computing node 750. A display or console hardware, in the context of the present system, may be used to provide output and receive input of a computing system; to manage components or services of a computing system; identify a state of a computing component or service; or to conduct any other number of management or administration functions or service use cases.

A battery 776 may power the computing node 750, although, in examples in which the computing node 750 is mounted in a fixed location, it may have a power supply coupled to an electrical grid, or the battery may be used as a backup or for temporary capabilities. The battery 776 may be a lithium-ion battery, or a metal-air battery, such as a zinc-air battery, an aluminum-air battery, a lithium-air battery, and the like.

A battery monitor/charger 778 may be included in the computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix, Arizona, or an IC from the UCD90xxx family from Texas Instruments of Dallas, TX. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the computing node 750. A wireless battery charging circuit, such as an LTC4020 chip from Linear Technologies of Milpitas, California, among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application-specific integrated circuit (ASIC).

In an example, the instructions 782 provided via the memory 754, the storage 758, or the processor 752 may be embodied as a non-transitory, machine-readable medium 760 (also referred to as a device-readable medium or storage medium) including code to direct the processor 752 to perform electronic operations in the computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 782 on the processor 752 (separately, or in combination with the instructions 782 of the machine-readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the computing node 750 through the TEE 790 and the processor 752.

In further examples, a machine-readable medium also includes any tangible medium that is capable of storing, encoding, or carrying instructions for execution by a machine and that causes the machine to perform any one or more of the methodologies of the present disclosure or that is capable of storing, encoding, or carrying data structures utilized by or associated with such instructions. A “machine-readable medium” thus may include, but is not limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus that is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, decrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations that, when joined logically together (e.g., including over a wire, over a network, using one or more platforms, wirelessly, via a software component, or the like), comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations, including over different storage devices, and may exist, at least partially, merely as electronic signals on a system or network. The components or modules may be passive or active, including agents operable to perform desired functions.

Additional examples of the presently described method, system, and device embodiments include the following non-limiting implementations provided in the claims and/or drawings. Each of the following non-limiting examples may stand on its own or may be combined in any permutation or combination with any one or more of the other examples provided below or throughout the present disclosure.

Example 1 is a method for preempting pipeline nodes in heterogeneous computing clusters, the method comprising: analyzing characteristics of a workload, the workload including future operations to be performed in at least one subsequent stage of a processing pipeline; identifying, based on the characteristics of the workload, at least one subsequent node projected to perform the at least one subsequent stage in the processing pipeline, the at least one subsequent node identified from among different node locations of a plurality of heterogeneous nodes; and providing a command to the at least one subsequent node, the command to preemptively change the at least one subsequent node into a ready state to perform the workload, wherein the at least one subsequent node is changed into the ready state before operations of the workload are transferred to the at least one subsequent node via the processing pipeline.

In Example 2, the subject matter of Example 1 optionally includes subject matter wherein the ready state to perform the workload includes use of a high-performance setting at the at least one subsequent node, the high-performance setting implemented with a change to at least one of: a circuitry performance mode; a processor core performance state; an input/output peripheral power state; or an accelerator device performance state.

In Example 3, the subject matter of any one or more of Examples 1-2 optionally includes subject matter wherein the command causes the at least one subsequent node to change from a low-power state to a high-performance state before the workload is transferred to the at least one subsequent node.

In Example 4, the subject matter of any one or more of Examples 1-3 optionally includes subject matter wherein the command causes the at least one subsequent node to stay in a high-performance state, which prevents a transition to a low-power state before the workload is transferred to the at least one subsequent node.

In Example 5, the subject matter of any one or more of Examples 1~4 optionally includes calculating an estimated time to perform respective tasks of the workload at individual nodes of the at least one subsequent node; and determining a specific time to perform the command at the individual nodes to preemptively change the individual nodes into the ready state, based on the estimated time to perform the respective tasks relative to time requirements of a service level agreement.

In Example 6, the subject matter of Example 5 optionally includes subject matter wherein the respective tasks to be performed at the individual nodes include use of at least one microservice at the individual nodes, and wherein the processing pipeline includes communicating results from an earlier node to a later node used in a sequence of the processing pipeline.

In Example 7, the subject matter of any one or more of Examples 1-6 optionally includes subject matter wherein the plurality of heterogeneous nodes is provided from a combination of at least two of: compute nodes, storage nodes, cryptographic acceleration nodes, or artificial intelligence (AI) acceleration nodes.

In Example 8, the subject matter of any one or more of Examples 1-7 optionally includes subject matter wherein the plurality of heterogeneous nodes is provided in a compute cluster, and wherein the device operates as an orchestrator or controller communicatively coupled to the compute cluster.

In Example 9, the subject matter of Example 8 optionally includes identifying at least one unused node of the compute cluster that is not scheduled to perform the workload, and wherein the orchestrator or controller provides at least one command to keep or transition the at least one unused node of the compute cluster into a reduced performance state.

In Example 10, the subject matter of any one or more of Examples 1-9 optionally includes subject matter wherein the command to preemptively change the at least one subsequent node into a ready state to perform the workload, includes preempting or reducing a priority of an active process at the at least one subsequent node, to reserve resources for the workload.

In Example 11, the subject matter of any one or more of Examples 1-10 optionally includes instantiating an additional node within the processing pipeline, in response to a determination that a subsequent node associated with a microservice has surpassed or is projected to surpass a resource utilization limit.

Example 12 is a device, comprising: processing circuitry; and a memory device including instructions embodied thereon, wherein the instructions, which when executed by the processing circuitry, configure the processing circuitry to perform operations for configuring or operating a computer by preempting pipeline nodes in heterogeneous computing clusters, in accordance with Examples 1 to 11 or other examples disclosed herein.

Example 13 is a method, comprising a plurality of operations executed with a processor and memory of a device, to perform operations for configuring or operating a computer by preempting pipeline nodes in heterogeneous computing clusters, in accordance with Examples 1 to 11 or other examples disclosed herein.

Example 14 is a non-transitory device-readable storage medium including instructions, wherein the instructions, when executed by a processing circuitry of a device, cause the processing circuitry to perform operations for configuring or operating a computer by preempting pipeline nodes in heterogeneous computing clusters, in accordance with Examples 1 to 11 or other examples disclosed herein.

Example 15 is an apparatus, comprising respective means for configuring or operating a computer by preempting pipeline nodes in heterogeneous computing clusters, in accordance with Examples 1 to 14 or other examples disclosed herein.

Example 16 is a network comprising respective devices and device communication mediums for performing any of the operations or techniques discussed herein, in accordance with Examples 1 to 15 or other examples disclosed herein.

Example 17 is a system comprising respective components arranged or configured to perform any of the operations or techniques discussed herein, in accordance with Examples 1 to 16 or other examples disclosed herein.

Example 18 is a method, performed using circuitry of a computing device, arranged or configured to perform any of the operations or techniques discussed herein, in accordance with Examples 1 to 17 or other examples disclosed herein.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer-readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read-only memories (ROMs), and the like.

What is claimed is:

1. A device, comprising:
processing circuitry; and
a memory device including instructions embodied thereon, wherein the instructions, which when executed by the processing circuitry, configure the processing circuitry to perform operations that:
analyze characteristics of a workload, the workload including future operations to be performed in at least one subsequent stage of a processing pipeline;
identify, based on the characteristics of the workload, at least one subsequent node projected to perform the at least one subsequent stage in the processing pipeline, the at least one subsequent node identified from among different node locations of a plurality of heterogeneous nodes; and
provide a command to the at least one subsequent node, the command to preemptively change the at least one subsequent node into a ready state to perform the workload, wherein the at least one subsequent node is changed into the ready state before operations of the workload are transferred to the at least one subsequent node via the processing pipeline.

2. The device of claim 1, wherein the ready state to perform the workload includes use of a high-performance setting at the at least one subsequent node, the high-performance setting implemented with a change to at least one of:
a circuitry performance mode;
a processor core performance state;
an input/output peripheral power state; or
an accelerator device performance state.

3. The device of claim 1, wherein the command causes the at least one subsequent node to change from a low-power state to a high-performance state before the workload is transferred to the at least one subsequent node.

4. The device of claim 1, wherein the command causes the at least one subsequent node to stay in a high-performance state, which prevents a transition to a low-power state before the workload is transferred to the at least one subsequent node.

5. The device of claim 1, wherein the instructions further configure the processing circuitry to perform operations that:
calculate an estimated time to perform respective tasks of the workload at individual nodes of the at least one subsequent node; and
determine a time to perform the command at the individual nodes to preemptively change the individual nodes into the ready state, based on the estimated time to perform the respective tasks relative to time requirements of a service level agreement.

6. The device of claim 5, wherein the respective tasks to be performed at the individual nodes include use of at least one microservice at the individual nodes, and wherein the processing pipeline includes communicating results from an earlier node to a later node used in a sequence of the processing pipeline.

7. The device of claim 1, wherein the plurality of heterogeneous nodes is provided from a combination of at least two of: compute nodes, storage nodes, cryptographic acceleration nodes, or artificial intelligence (AI) acceleration nodes.

8. The device of claim 1, wherein the plurality of heterogeneous nodes is provided in a compute cluster, and wherein the device operates as an orchestrator or controller communicatively coupled to the compute cluster.

9. The device of claim 8, wherein the instructions further configure the processing circuitry to perform operations that:
identify at least one unused node of the compute cluster that is not scheduled to perform the workload, and wherein the orchestrator or controller provides at least one command to keep or transition the at least one unused node of the compute cluster into a reduced performance state.

10. The device of claim 1, wherein the command to preemptively change the at least one subsequent node into a ready state to perform the workload, includes preempting or reducing a priority of an active process at the at least one subsequent node to reserve resources for the workload, wherein the active process is not associated with the workload.

11. A non-transitory machine-readable storage medium comprising instructions that, when executed by processing circuitry of a computing system, cause the processing circuitry to perform operations that:
analyze characteristics of a workload, the workload including future operations to be performed in at least one subsequent stage of a processing pipeline;
identify, based on the characteristics of the workload, at least one subsequent node projected to perform the at least one subsequent stage in the processing pipeline, the at least one subsequent node identified from among different node locations of a plurality of heterogeneous nodes; and
provide a command to the at least one subsequent node, the command to preemptively change the at least one subsequent node into a ready state to perform the workload, wherein the at least one subsequent node is changed into the ready state before operations of the workload are transferred to the at least one subsequent node via the processing pipeline.

12. The non-transitory machine-readable storage medium of claim 11, wherein the ready state to perform the workload includes use of a high-performance setting at the at least one subsequent node, the high-performance setting implemented with a change to at least one of:
a circuitry performance mode;
a processor core performance state;
an input/output peripheral power state; or
an accelerator device performance state.

13. The non-transitory machine-readable storage medium of claim 11, wherein the command causes the at least one subsequent node to:
change from a low-power state to a high-performance state before the workload is transferred to the at least one subsequent node; or
stay in a high-performance state, which prevents a transition to a low-power state before the workload is transferred to the at least one subsequent node.

14. The non-transitory machine-readable storage medium of claim 11, wherein the instructions further configure the processing circuitry to perform operations that:
calculate an estimated time to perform respective tasks of the workload at individual nodes of the at least one subsequent node; and
determine a time to perform the command at the individual nodes to preemptively change the individual nodes into the ready state, based on the estimated time to perform the respective tasks relative to time requirements of a service level agreement;
wherein the respective tasks to be performed at the individual nodes include use of at least one microservice at the individual nodes, and wherein the processing pipeline includes communicating results from an earlier node to a later node used in a sequence of the processing pipeline.

15. The non-transitory machine-readable storage medium of claim 11, wherein the plurality of heterogeneous nodes is provided in a compute cluster, wherein the computing system operates as an orchestrator or controller communicatively coupled to the compute cluster, and wherein the plurality of heterogeneous nodes is provided from a combination of at least two of: compute nodes, storage nodes, cryptographic acceleration nodes, or artificial intelligence (AI) acceleration nodes.

16. A method, performed with a plurality of operations executed with at least one processor and memory of a computing system, the method comprising:
analyzing characteristics of a workload, the workload including future operations to be performed in at least one subsequent stage of a processing pipeline;
identifying, based on the characteristics of the workload, at least one subsequent node projected to perform the at least one subsequent stage in the processing pipeline, the at least one subsequent node identified from among different node locations of a plurality of heterogeneous nodes; and
transmitting a command to the at least one subsequent node, the command to preemptively change the at least one subsequent node into a ready state to perform the workload, wherein the at least one subsequent node is changed into the ready state before operations of the workload are transferred to the at least one subsequent node via the processing pipeline.

17. The method of claim 16, wherein the ready state to perform the workload includes use of a high-performance setting at the at least one subsequent node, the high-performance setting implemented with a change to at least one of:
a circuitry performance mode;
a processor core performance state;
an input/output peripheral power state; or
an accelerator device performance state.

18. The method of claim 16, wherein the command causes the at least one subsequent node to:
change from a low-power state to a high-performance state before the workload is transferred to the at least one subsequent node; or
stay in a high-performance state, which prevents a transition to a low-power state before the workload is transferred to the at least one subsequent node.

19. The method of claim 16, further comprising:
calculating an estimated time to perform respective tasks of the workload at individual nodes of the at least one subsequent node; and
determining an execution time to perform the command at the individual nodes to preemptively change the individual nodes into the ready state, based on the estimated time to perform the respective tasks relative to time requirements of a service level agreement;
wherein the respective tasks to be performed at the individual nodes include use of at least one microservice at the individual nodes, and wherein the processing pipeline includes communicating results from an earlier node to a later node used in a sequence of the processing pipeline.

20. The method of claim 16, wherein the plurality of heterogeneous nodes is provided in a compute cluster, wherein the computing system operates as an orchestrator or controller communicatively coupled to the compute cluster, and wherein the plurality of heterogeneous nodes is provided from a combination of at least two of: compute nodes, storage nodes, cryptographic acceleration nodes, or artificial intelligence (AI) acceleration nodes.
